(19) United States
(12) Patent Application Publication
(10) Pub. No.: US 2017/0004188 A1
(43) Pub. Date: Jan. 5, 2017

(54) Apparatus and Method for Graphically Displaying Transaction Logs

(71) Applicant: CA, Inc., New York, NY (US)

(72) Inventor: Vishal Gupta, Bangalore (IN)

(21) Appl. No.: 14/754,880

(22) Filed: Jun. 30, 2015

(51) Int. Cl. G06F 17/30

(52) U.S. Cl. CPC G06F 17/30572; G06F 17/30377; G06F 17/30554

(57) ABSTRACT

A computing device obtains and analyzes the log entries of a log file, and generates an interactive graph that visually represents the results of the analysis to output to a display device. More particularly, the device groups each log entry in the log file into a corresponding pattern, and then generates the graph to plot the line numbers of the log entries to their corresponding patterns. The plot is formed as a wave to make it easy for a user to identify patterns of commands and actions that are executed in the performance of a given task, as well as for determining whether an underlying system is exhibiting anomalous behavior.

### BACKGROUND

The present disclosure relates generally to computer-implemented methods for analyzing log files, and more particularly, to computing devices configured to graphically represent the results of such an analysis on a display to a user.

Many application programs produce log files as part of their normal operating process. For example, database programs, such as DB2, ORACLE, and the like, maintain one or more transaction logs that contain a variety of information. The transaction logs are a sequential record of changes made to the database as part of an individual database transaction. The actual changes to the data are, of course, maintained by the database in one or more separate flies; however, transaction logs contain enough information to undo all those changes should the need arise.

Application programs may create and maintain their log files as text-based files or binary files. In either case, there are existing tools to display the information in the log files on a display screen. However, these tools typically display the log information as text in a tabular format. Because most log files contain an extremely large amount of data, it is notoriously difficult for users to analyze and glean any meaningful information from the log files.

### BRIEF SUMMARY

The present disclosure provides a method, apparatus, and corresponding computer-readable storage medium obtaining and analyzing the log entries of a log file, and for generating an interactive graph to visually represent the results of the analysis to a user on a display device. Particularly, embodiments of the present disclosure help the user to visualize the content of the log files as a spatial series, and thus, make it easier for the user to identify patterns of commands and actions that are executed by a computing device in the performance of a given task, as well as anomalous behavior.

In one embodiment, a computer-implemented method comprises obtaining, by a processing circuit, a log file from a memory circuit. The log file comprises a plurality of log entries, with each log entry being identified by a corresponding line number. Additionally, the method comprises generating, by the processing circuit, a list that maps the line number of each log entry to a corresponding pattern of log entries. Each corresponding pattern of log entries is identified by a pattern number and represents a task performed by the computing device. The method also calls for computing, by the processing circuit, a pattern value for each pattern in the list, and detecting, by the processing circuit, an anomalous pattern in the list. The method then comprises outputting, by the processing circuit, an interactive graph to a display device. The interactive graph plots the pattern value for a pattern in the list to the line number of a representative log entry in that pattern, and visually indicates the anomalous pattern to the user.

In another embodiment, the present disclosure provides a computing device comprising a communications interface circuit and a processing circuit. The communications circuit communicatively connects to a communications network and the processing circuit. The processing circuit is configured to obtain a log file comprising a plurality of log entries, wherein each log entry is identified by a corresponding line number, generate a list that maps the line number of each log entry to a corresponding pattern of log entries, wherein each corresponding pattern of log entries is identified by a pattern number and represents a corresponding task performed by a computer, compute a pattern value for each pattern in the list, and detect an anomalous pattern in the list. The processing circuit is also configured to output an interactive graph to a display device, wherein the interactive graph plots the pattern value for a pattern in the list to the line number of a representative log entry in that pattern, and visually indicates the anomalous pattern to the user.

In one embodiment, the present disclosure provides a computer-readable storage medium. The computer-readable storage medium stores computer program code that, when executed by a processing circuit of a computing device, configures the processing circuit to obtain a log file comprising a plurality of log entries, wherein each log entry is identified by a corresponding line number, generate a list that maps the line number of each log entry to a corresponding pattern of log entries, wherein each corresponding pattern of log entries is identified by a pattern number and represents a corresponding task performed by the computing device, compute a pattern value for each pattern in the list, and detect an anomalous pattern in the list. Additionally, the computer program code, when executed by the processing circuit, configures the processing circuit to display an interactive graph on a display device for a user, wherein the interactive graph plots the pattern value for a pattern in the list to the line number of a representative log entry in that pattern, and visually indicates the anomalous pattern to the user.

Of course, those skilled in the art will appreciate that the present embodiments are not limited to the above contexts or examples, and will recognize additional features and advantages upon reading the following detailed description and upon viewing the accompanying drawings.

### BRIEF DESCRIPTION OF THE DRAWINGS

Aspects of the present disclosure are illustrated by way of example and are not limited by the accompanying figures with like references indicating like elements.

FIG. 1 is a block diagram illustrating some components of a computer network configured according to one embodiment of the present disclosure.

FIG. 2 illustrates log file information of a type suitable for analysis acoring to embodiments of the present disclosure.

FIG. 3 illustrates an interactive graph generated based on an analysis of the log entries in a log file according to one embodiment of the present disclosure.

FIG. 4 is a flow diagram illustrating a method for generating an interactive graph according to one embodiment of the present disclosure.

FIG. 5 is a flow diagram illustrating a method for analyzing the log entries in a log file according to one embodiment of the present disclosure.

FIG. 6 is a flow diagram illustrating a method for assigning log entries to a corresponding pattern according to one embodiment of the present disclosure.

FIG. 7 is a flow diagram illustrating a method for detecting an anomalous pattern of log entries according to one embodiment of the present disclosure.

FIG. 8 illustrates an interactive graph generated according to one embodiment of the present disclosure.

FIG. 9 is a block diagram illustrating some functional components of an exemplary computer device configured to generate an interactive graph according to one embodiment of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely as hardware, entirely as software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Pen, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

Accordingly, the present disclosure provides a computing device, a computer-implemented method, and a computer-readable storage medium configured for obtaining and analyzing the log entries of a log file, and for generating an interactive graph for display to a user to visually represent the results of the analysis. More specifically, embodiments of the present disclosure plot the line numbers of the log entries in a log file as a spatial series, with the line numbers being plotted as a wave. For illustrative purposes only, the log file may comprise a transaction log that contains transaction entries associated with database transactions.

During the analysis, the computing device identifies log entries that are related to a given task (e.g., a database transaction such as “Add an Employee” or “Check Account Balance”), and assigns related log entries into corresponding groups referred to herein as “patterns.” Assignment is based on the results of a mathematical computation that indicates a measure of how similar the log entries are to each other. The computing device then computes a numerical value for each of the patterns, and generates an interactive graph that plots the numerical values of the patterns against the line numbers of representative log entries in those patterns. The result is a graphical representation of the log file contents that facilitates a user's ability to quickly and easily visually analyze and understand the characteristics of the system performing the tasks.

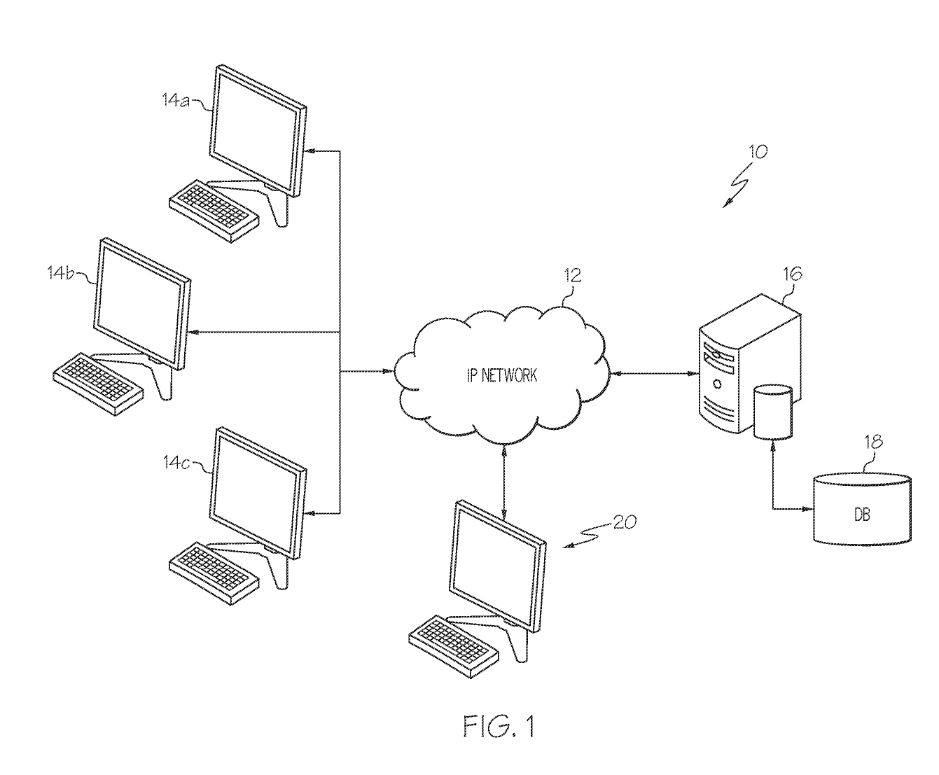

Turning to the drawings, FIG. 1 is a block diagram illustrating some components of a computer network 10 configured according to one embodiment of the present disclosure. As those of ordinary skill in the art will readily appreciate, the components of network 10 shown in FIG. 1 are for illustrative purposes only. That is, communication networks suitable for configuration according to the present embodiments may comprise more or fewer components, or in some cases, components that are different than those illustrated in FIG. 1. Additionally, it should be noted that the present embodiments are described in the context of database transactions and their related data objects. However, the specific mention of any database specific terminology or concept is for illustrative purposes only. The present embodiments may be utilized to graphically represent the results of an analysis performed on the content of any type of log file, regardless of whether the log file is or is not associated with the execution of database commands. Thus, embodiments of the present disclosure may be utilized on log files that are associated with non-database related applications.

As seen in FIG. 1, network 10 comprises a packet-data network 12 that communicatively interconnects a plurality of user terminals 14a, 14b, 14c (collectively, user terminals 14) and a control computer 20 with a database (DB) server 16. Additionally, DB server 16, which may comprise any application server known in the art, communicatively connects to a data storage device 18. Generally, application programs executing at the user terminals 14 communicate with a database program (e.g., DB2, ORACLE, and the like) executing on DB server 16 to store data to, and retrieve data from, storage device 18 in a series of transactions. As part of that process, a database program executing on DB server 16 generates and maintains one or more log files for storage in a memory device, such as storage device 18. The log files, as described in more detail later, contain information associated with the transactions executed by the application programs running on user terminals 14 and may be used, for example, in database recovery and rollback operations. The control computer 20, which is also described in more detail later, is configured to analyze the information stored in the log files, and generate a graphical representation of that analysis for display to the user. In this capacity, the control computer 20 transforms the underlying log data into an interactive graphical representation that aids a Database Administrator (DBA) or other such user in managing the database.

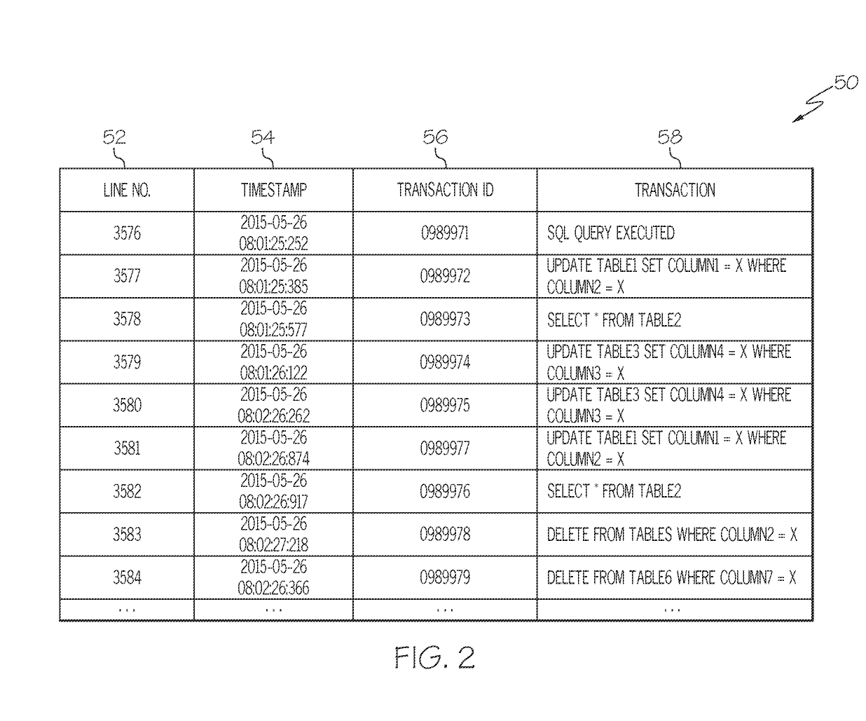

FIG. 2 illustrates an example of the type of data that may be stored in a log file suitable for analysis according to various embodiments of the present disclosure in a table 50. Those of ordinary skill in the art will realize that the log entry data seen in FIG. 2 is merely illustrative, and that transaction logs may contain information in lieu of, or in addition to, the information seen in FIG. 2.

The log files are generated by an application program, such as the database program executing on DB server 16. Each log entry (i.e., row of data) displayed in table 50 contains information regarding a particular command or action that was executed by the application program in the performance of a given task. Such tasks include, but are not limited to, adding and deleting employees from the database, updating tables related to employees in the database, monitoring and/or updating the value of assets in a given account, and the like. Thus, tasks may be defined by the execution of a single command or action, or by the execution of a plurality of related commands or actions.

As seen in FIG. 2, table 50 comprises a plurality of columns of data. Although table 50 may contain any data needed or desired, table 50 of this embodiment includes a line number column 52, a timestamp column 54, a transaction ID column 56, and a transaction column 58.

The line number column 52 stores an integer that uniquely identifies each log entry in the log file. This number is a sequential number automatically generated by the application program that generates and maintains the log file. As seen in more detail later, the line numbers in the line number column 52 are utilized by the present disclosure during the analysis of the log file contents to generate the interactive graph that is displayed to a user.

The timestamp column 54 comprises information identifying when (i.e., a date and time) the particular command in the transaction column 58 was executed by the application program, while the transaction ID column 56 stores a unique integer that identifies that transaction. Like the line number in line number column 52, the transaction ID is typically a sequential integer value automatically generated by the application program executing the corresponding command in the transaction column 58.

The data in the transaction column 58 comprises the commands and actions that were executed by the application program. As seen in FIG. 2, such commands may comprise Standard Query Language (SQL) commands; however, this is for illustrative purposes only. The data in the transaction column 58 may comprise any type of command or action known in the art and thus, is not limited solely to those associated with SQL based transactions. In some cases, the particular data values associated with the commands and actions may also be reflected in transaction column 58, but this is not required.

Those of ordinary skill in the art will readily appreciate that the log file may comprise other data in addition to, or in lieu of, the data seen in table 50. Although not specifically shown, such data includes, but is not limited to, Universal Resource Locators (URLs) of the user terminals 14 that causes a given command to be executed, application IDs that identify a particular application program invoking the command to be executed, object IDs that identify various objects (e.g., tables, etc.) that are modified as a result of a given command, user IDs that identify the user initiating the tasks or commands, and unit of recovery (UR) values that correspond to a set of related commands in table 50.

As stated above, the application program that creates and maintains the log file contents seen in table 50 performs various tasks. Each task comprises a sequence of one or more related commands. Thus, a single task may be reflected in table 50 by a plurality of different log entries—each identifying the related commands or actions performed sequentially over a period of time. Conventional tools that are configured to display the log data for the user will generally organize the data in tabular format. However, log files typically comprise a very large amount of data. Further, because of the manner in which the application program executes the commands, the log entries associated with different tasks are usually interspersed throughout the log file. Thus, it is difficult to organize and display the log entries in a manner that allows a user to easily discern certain patterns of commands, or to easily glean information about the operation of the underlying system.

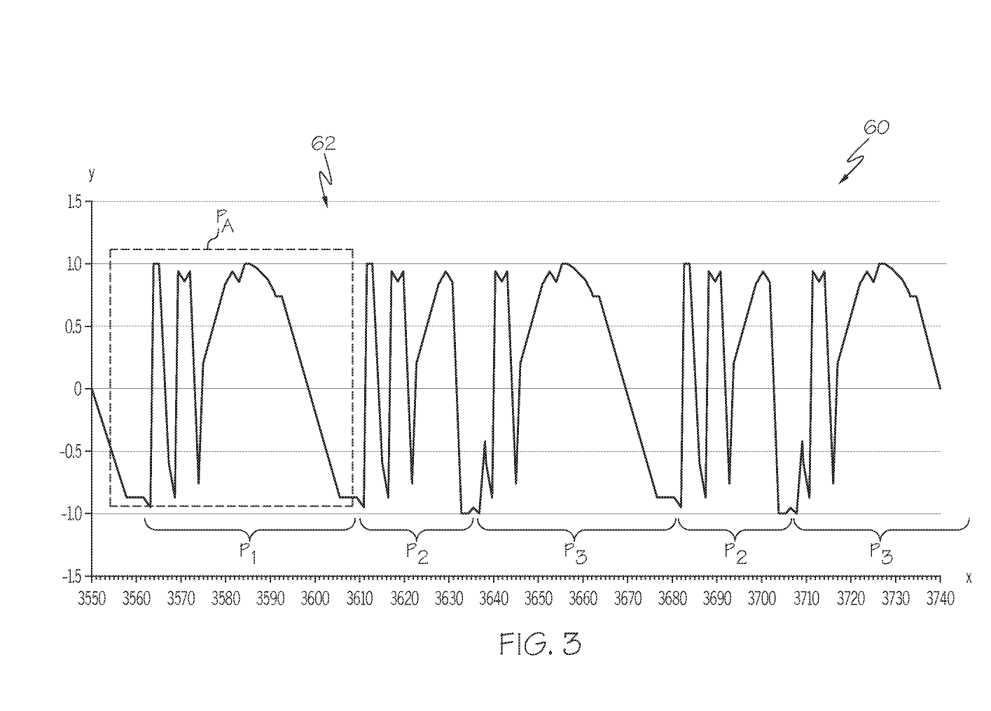

Embodiments of the present disclosure therefore generate a graphical representation of the log entry data for display to the user. For example, as seen in FIG. 3, one embodiment of the present disclosure outputs a Graphical User Interface (GUI) 60 to a display device. The GUI comprises a line graph 62 that is generated, according to embodiments of the present disclosure, based on an analysis of the log entry data contained in the log file. As seen in FIG. 3, the line graph 62 plots the line numbers (seen along the X-axis) of representative log entries to a “pattern value” (seen along the Y-axis). As described in more detail below, a “pattern value” is a computed value that uniquely identifies the pattern with which a given representative log entry is associated.

Graph 62 is generated to plot the information as a wave. Thus, simply by looking at graph 62, a user is able to discern various patterns of commands that are executed by the application program. For example, the embodiment seen in FIG. 3 illustrates three (3) patterns—P₁, P₂, and P₃. Some patterns, such as patterns P₂ and P₃, are repeating patterns. Further, these patterns are performed multiple times in relatively close succession. Thus, a user (e.g., a DBA) viewing graph 62 on GUI 60 may determine that the commands associated with patterns P₂ and P₃ are performed more times and more regularly than the commands associated with pattern P₁. Armed with this insight, the user may determine that the sizes of the tables and indices affected by the commands in patterns P₂ and P₃ could increase more rapidly than the tables and indices affected by commands associated with other patterns, such as pattern P₁. Therefore, the user may proactively increase the size of one or more tablespaces to prevent a situation where the tables and indices grow too quickly. Thus, the graph 62 generated according to the present disclosure transforms the data contained in the log file to a graphical indication that allows a user to visually understand a characteristic of the database very quickly, and in response, proactively avoid possible problems.

In addition to facilitating proactive functions by the user, embodiments of the present disclosure will also automatically detect whether a given pattern is an “anomalous pattern,” and if so, graphically indicate that pattern on line graph 62. According to the present disclosure, an “anomalous pattern” is a pattern that deviates from an expected or baseline pattern by at least a predetermined amount. In some embodiments, such as the embodiment seen in FIG. 2, whether a pattern is an anomalous pattern is discernable by visually comparing the shape and/or size of the wave that represents the pattern compared to the size and/or shape of the wave generated to represent the baseline pattern.

For example, as seen in FIG. 3, the peaks and valleys that comprise pattern P₁ do not match any of the other patterns (e.g., P₂ and P₃) seen in FIG. 3. While this difference alone may not be determinative of a problem, it can indicate that a problem is occurring, or has occurred, with the underlying database. Therefore, embodiments of the present disclosure automatically detect such anomalous patterns P_{A}, and graphically indicate such patterns on the line graph 62. In this embodiment, pattern P₁ is identified as an anomalous patter P_{A} by surrounding the pattern P₁ with a border that draws the user's attention to pattern P₁. However, it should be well understood that other methods for indicating anomalous patterns are also possible.

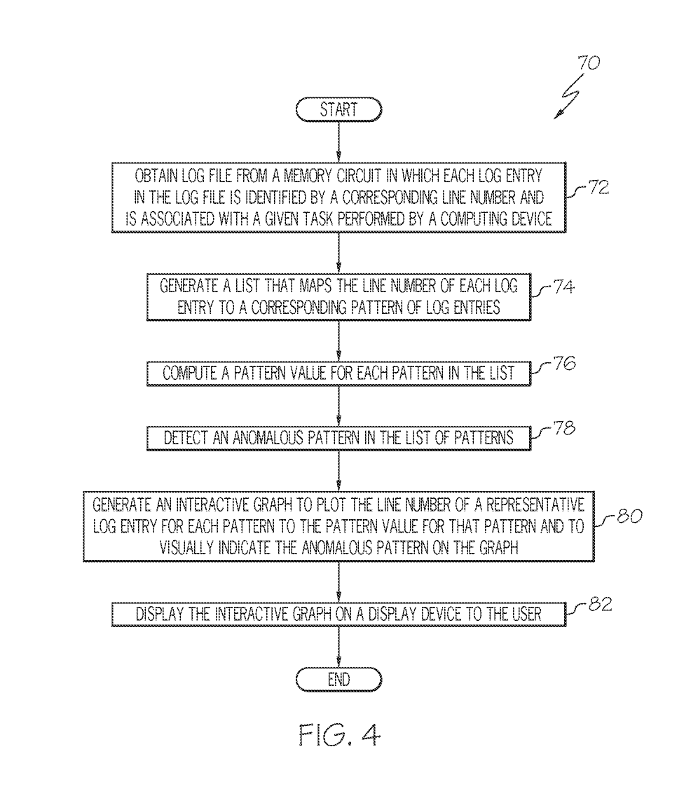

FIG. 4 is a flow diagram illustrating a method 70 for analyzing the contents of a log file, and using that analysis to generate an interactive graph representing the results of that analysis. For illustrative purposes only, method 70 is described as being performed by the control computer 20. However, those of ordinary skill in the art should readily appreciate that other computing devices (e.g., database servers, application servers, etc.) are also well-suited to be configured to perform the embodiments described herein.

As seen in FIG. 4, method 70 begins with the control computer 20 obtaining a log file from a memory circuit (box 72). The log file comprises a plurality of log entries identified by corresponding line numbers, and each log entry is associated with a given task performed by an application program. The log file may be retrieved, for example, from storage device 18, locally from a memory of control computer 20, or from some other memory circuit accessible to control computer 20.

Upon obtaining the log file, control computer 20 will generate a list that maps the specific line number of each log entry in the log file to a corresponding pattern (box 74). As stated above, each pattern is associated with a particular task (e.g., Add an Employee, Obtain Account Balance, etc.), and comprises the one or more log entries that were created by the application program in the performance of that task. Further, each pattern is identified by a unique integer value referred to herein as a pattern ID. Once the list has been generated, the control computer 20 computes a “pattern value” for each pattern in the list. The “pattern value” is a number computed for the pattern and defines the Y-axis of the line graph 62. Control computer 20 also detects whether any of the patterns in the list are anomalous patterns P_{A} (box 78).

Once control computer 20 has computed the data, control computer 20 generates an interactive line graph 62 (box 80). Specifically, control computer 20 plots the line number of a representative log entry in each pattern against the pattern values for the patterns. Control computer 20 then outputs the generated line graph 62 to a display device, and indicates on the graph 62, if necessary, whether any of the patterns detected during the analysis are anomalous patterns P_{A} (box 82). As was seen in FIG. 3, control computer 20 may, for example, outline an anomalous pattern P_{A} with a highlighted box, or generate the graph 62 such that the anomalous pattern is displayed in a color that is different from that of the non-anomalous patterns in graph 62. Other methods for indicating a particular pattern as being an anomalous pattern P_{A} are also possible.

As stated above, control computer 20 generates a list that maps the specific line number of each log entry in the log file to a corresponding pattern, and each corresponding pattern is associated with a particular task. Thus, each log entry that is grouped into a given pattern is related to all the other log entries in that pattern since the commands and actions identified in those log entries are all executed in performance of the same task.

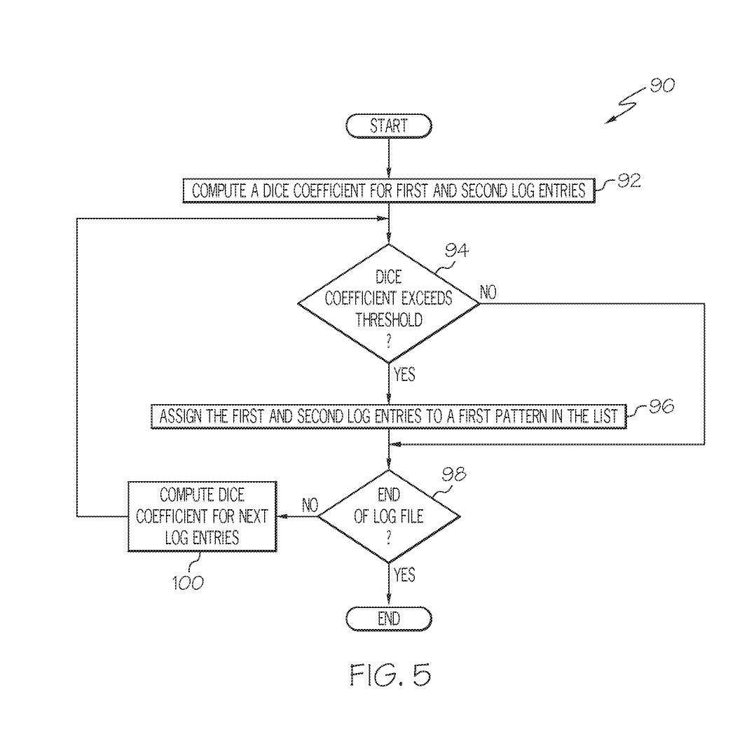

There are many different ways for grouping the log entries to generate the list. However, one embodiment of the present disclosure, seen in FIG. 5, groups log entries based on a measure of their similarity. More specifically, the log entries of a given log file usually contain the same information or type of information, such as the same constant text (e.g., SQL commands, etc.), parameters (e.g., employee name, account number, etc.), parameter types (e.g., string, floating point number, etc.), and parameter values, for example. The fact that two different log entries have the same or similar data, therefore, is an indication of whether those log entries are similar, and thus, should be associated with the same pattern.

In this embodiment, the control computer 20 determines whether two different log entries are the same or similar using a dice coefficient. Normally, a dice coefficient is a statistical computation used for determining the similarity of two samples. However, according to the present disclosure, it is used to measure the lexical similarity of two log entries.

Method 90 of FIG. 5 is a flow diagram that illustrates how one embodiment of the present disclosure measures the lexical similarity of two log entries using a dice coefficient. Particularly, method 90 begins with the control computer 20 calculating the dice coefficient for first and second log entries (box 92). In one embodiment, the computation is performed using the formula:

$$s = \frac{2 {n}_{t}}{{n}_{x} + {n}_{y}}$$

where: s is the dice coefficient;
nₜ is the intersection of the two log entries;
nₓ is the number of elements in the first log entry; and
n_{y} is the number of elements in the second log entry.

As an example, consider the following two log entries A and B.

A: UPDATE TABLE1 SET COLUMN1 = ‘SMITH’ WHERE
COLUMN2=’JANE’
B: UPDATE TABLE3 SET COLUMN4 = ‘SMITH’ WHERE
COLUMN4=’JANE’

Each entry is associated with an UPDATE function that is performed on a different table. However, it may be that the tables of a given database are updated whenever a particular task is performed, such as whenever the information for an employee is added or modified. Therefore, these two log entries may be related in that the UPDATE commands are executed in performance of the same task.

To perform the computation, control computer 20 parses each of the log entries into their constituent terms. Thus, after parsing, log entries A and B could reflect:

A: ‘UPDATE’ ‘TABLE1’ ‘SET’ ‘COLUMN1’ ‘=’ “SMITH” ‘WHERE’
‘COLUMN2’ =’ ‘’JANE”
B: ‘UPDATE’ ‘TABLE3’ ‘SET’ ‘COLUMN4’ ‘=’ “SMITH” ‘WHERE’
‘COLUMN4’ ‘=’ ‘’JANE”

Each log entry has 10 terms (nₓ, n_{y}) for a total of 20 terms. The terms are then compared to reveal that 7 of the terms are the same. This is the intersection nₜ of the two log entries. Using these numbers, the dice coefficient can be calculated.

$$s = \frac{2 \times 7}{10 + 10} = 0.7$$

The computed dice coefficient (i.e., 0.7) is then compared to a predetermined threshold value that may be defined, for example, by a user (box 94). If the computed dice coefficient equals or exceeds the predetermined threshold value, the first and second log entries are considered to be similar and assigned to the same pattern (box 96). If the computed dice coefficient is less than the predetermined threshold value, the second log entry is simply discarded as not related. In either event, control computer 20 then determines whether it has reached the end of the log file (box 98). If so, it means that all log entries have been processed and the method 90 ends. If not, control computer 20 reads and processes a third log entry to compute the dice coefficient (box 100), compares the computed dice coefficient to the predetermined threshold (box 94), and assigns the third log entry to a corresponding pattern in accordance with the results of the comparison (box 96).

It should be noted that in one embodiment, method 90 is performed for each log entry in the log file. Thus, each log entry in the log file will be compared to each of the other log entries in the log file at least once. For example, given a log file with 5 log entries, control computer 20 will first perform method 90 to determine the similarity of log entry 1 to each of log entries 2-5. Once that processing is complete, control computer 20 will repeat method 90 to determine the similarity of log entry 2 to each of the log entries 3-5. Then control computer 20 would continue processing to determine the similarity of log entry 3 to each of the log entries 4-5, and finally, determine the similarity of log entry log entry 4 to log entry 5. With each comparison (box 94), one or both of the log entries are assigned to an existing pattern (if the log entries are not already assigned to that pattern), or if no pattern exists, a new pattern is created and the log entries are assigned. Regardless, the result of method 90 is a listing that maps the log line number (e.g., 1 . . . 1) of each log entry in the log file to the pattern number (e.g., 1 . . . n) of a corresponding pattern.

Like the computations for measuring the similarity of two log entries, there are also various methods by which control computer 20 may compute the “pattern value” for each pattern. In one embodiment, control computer 20 utilizes the following formula to compute the pattern value for each pattern.

$$P ( n ) = \frac{n \times 2 π}{t}$$

where: P(n) is the pattern value for the n^{th} pattern;
n is the pattern number (1 . . . n) for the n^{th} pattern;
2π is a scaling factor; and
t is the total number of patterns.

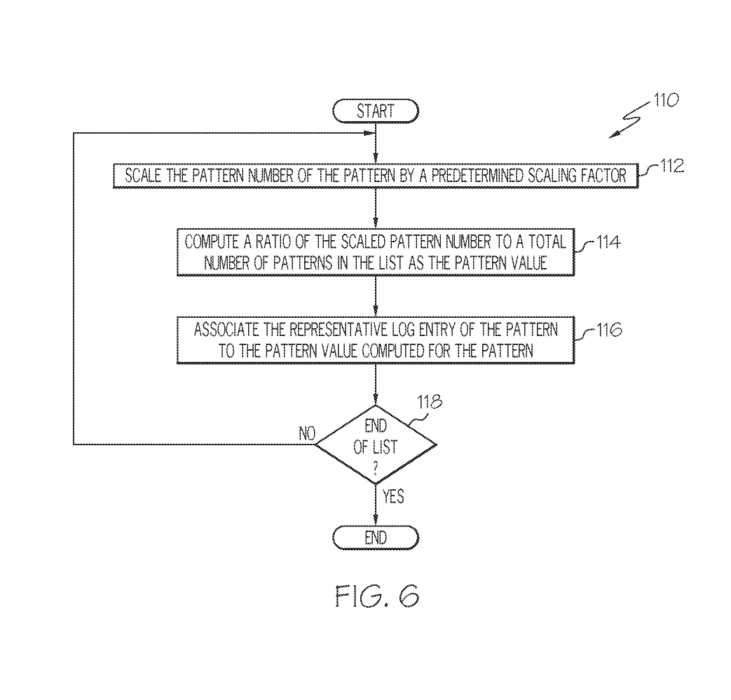

FIG. 6 is a flow diagram that illustrates a method 110 by which control computer uses the equation above to compute a pattern value for each pattern. As seen in FIG. 6, control computer 20 first scales the pattern number (i.e., the integer that uniquely identifies a pattern) of a given pattern in the list by the scaling factor 2π (box 112). The scaling factor allows control computer 20 to compute the pattern values P(n) to facilitate plotting the log line numbers as a wave form. Control computer 20 then computes the ratio of the scaled pattern number to the total number of patterns in the list (box 114). Then, control computer 20 associates a representative log line number for the log entries in the given pattern to the pattern value P(n) computed for that pattern (box 116). Such association may be performed, for example, by modifying the list that maps the log line numbers to the corresponding patterns to also map at least one log entry for each pattern to the calculated pattern value P(n). Alternatively, control computer 20 can create a new list that maps at least one log entry for each pattern to the calculated pattern value P(n). However, regardless of the particular method of mapping, embodiments of the present disclosure map the log line number of each log entry in the log file to a particular pattern number, and a representative log line number of a log entry in a given pattern to a pattern value calculated for that pattern.

As seen in FIG. 6, control computer 20 will iterate through the entire list that maps the log line numbers to the pattern numbers. When control computer 20 determines that it has reached the end of that list (box 118), method 110 ends.

As stated above, control computer 20 generates the graph 62 for GUI 60 by mapping the log line numbers of the log entries to the pattern values calculated for each pattern. In addition, however, control computer 20 is also configured to automatically detect whether a given pattern in the list is an anomalous pattern P_{A}. There are a variety of methods by which control computer 20 may determine such divergence, but in one embodiment, control computer 20 utilizes a Kullback-Leibler divergence.

A Kullback-Leibler divergence, as is known in the art, is a non-symmetric measure of the difference between two probability distributions. According to embodiments of the present disclosure, this divergence is computed for two patterns in two different time windows (i.e., a baseline pattern in a first time window, and a selected pattern in a subsequent time window) and then compared to determine whether one pattern differs from the other, and if so, by how much.

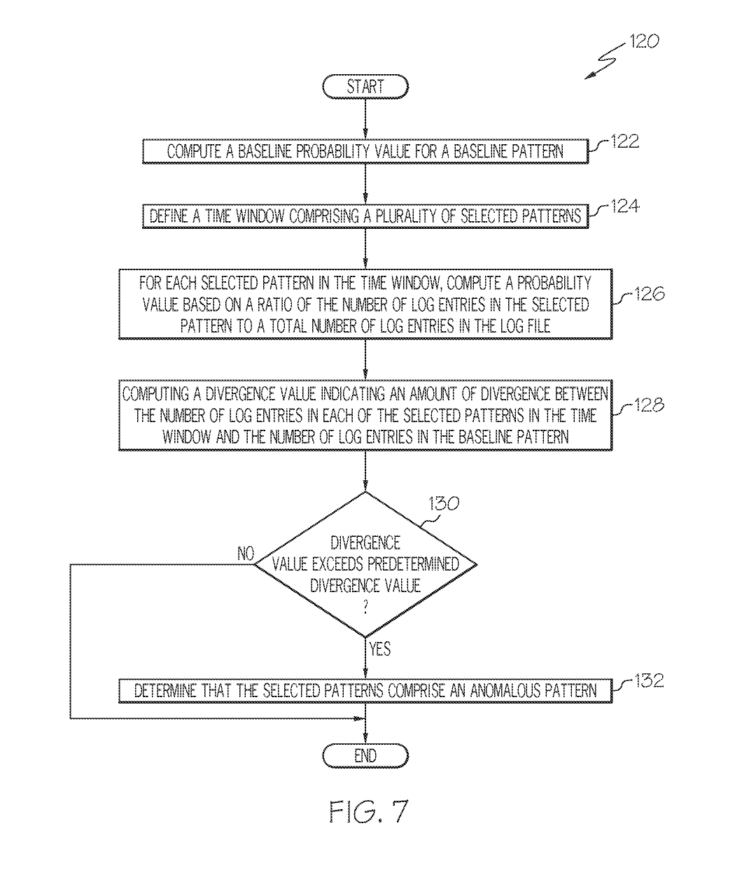

In more detail, FIG. 7 is a flow diagram illustrating one method 120 for utilizing a Kullback-Leibler divergence to a measure of divergence between two patterns. As seen in FIG. 7, control computer 20 first computes a baseline probability vector P_{b} for a baseline pattern (box 122) using:

$${p}_{b} = \frac{n - len}{t - len}$$

where: p_{b} is the baseline probability vector;
n is the total number of log lines in the pattern that is used as the baseline pattern; and
t is the total number of log lines in the log file.
   The time window defined for the baseline probability vector p_{b} may be any time window defined by a user, for example, and further, may be as long or short as needed or desired.

Subsequently, control computer 20 defines a time window for testing one or more other patterns against the baseline pattern (box 124). As above, the time window may be explicitly defined by a user, or alternatively, may be automatically computed by the control computer 20 based, for example, on a learned knowledge of the times that typically constrain the log entries for a pattern. In these latter cases, control computer 20 may compute a time window using the timestamps associated with the log entries in one or more given patterns. That is, the time window could equal the elapsed time between the timestamp associated with the earliest log entry assigned to the pattern and the timestamp for the most recent log entry assigned to the pattern.

Thereafter, control computer 20 computes a probability vector p(n) for each of the patterns in the subsequently defined time window (box 126) using the same equation that was employed to compute the baseline probability vector p_{b}. Thus, the probability vector p(n) for each pattern is also computed as a ratio of the number of log entries in pattern n to the total number of log entries t in the log file.

Once a probability vector p(n) has been computed for each pattern in the selected time window, control computer 20 detects whether any of those patterns constitute an anomalous pattern P_{A}. To accomplish this, one embodiment of the present disclosure computes a divergence value D for the vectors p_{b}, p(n). The divergence value D indicates an amount of divergence between the log entries in each of the patterns in the time window and the log entries in the baseline pattern (i.e., how different the log entries in each of the patterns in the time window are from the log entries in the baseline pattern (box 128). In one embodiment, the divergence value D is computed using:

$$D = {\sum }_{i = 1}^{n} {p}_{b} ⋆ log \frac{{p}_{b}}{p ( n )}$$

where: p_{b} is the computed baseline probability vector;
n is the pattern number of the pattern being evaluated; and
p(n) is the probability vector for the n^{th} pattern.

Once control computer 20 has computed divergence value D, control computer 20 will compare the divergence value D to a predetermined divergence threshold (box 130). If the computed divergence value D exceeds the threshold, control computer 20 determines that the pattern or patterns in the predefined time window diverge significantly from the accepted baseline pattern (box 132). In these cases, control computer 20 will identify the pattern(s) as anomalous pattern(s) P_{A}, and generate and/or modify graph 62 to visually indicate these anomalous pattern(s) P_{A} in GUI 60. As seen previously in FIG. 3, the visual indication may comprise graphically indicating the anomalous pattern P_{A} with a conspicuous border, or showing the anomalous pattern(s) P_{A} in a color that is different than the color used for patterns that do not diverge from the baseline pattern.

The previously described embodiments illustrate the present disclosure simply as comprising a graph 62 that is generated based on several computations with respect to the actual contents of the log entries in a log file of interest. Indeed, the graph 62 helps a user to visualize the information that is contained in a log file, and thus, assists the user in being able to visually identify patterns of commands or actions performed by a device, as well as to identify possibly unusual behaviors for a system such that the user may proactively address any issues.

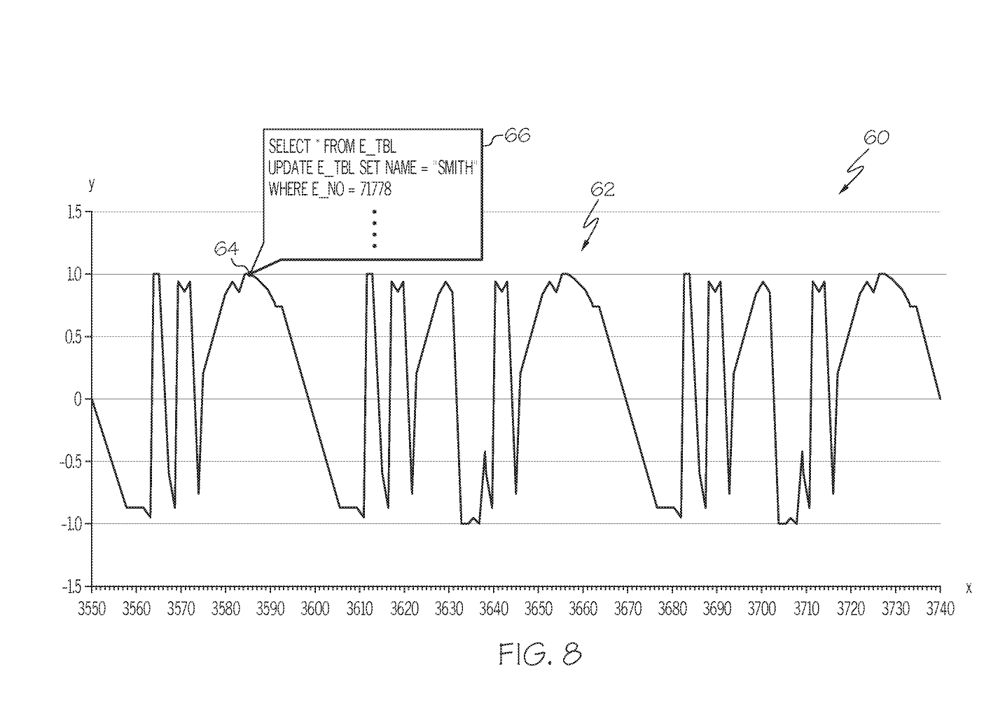

However, those of ordinary skill in the art should readily appreciate that the present disclosure is not so limited. In another embodiment, seen in FIG. 8, control computer 20 can also provide the user with additional information about the log entries of a particular pattern as well. More specifically, the control computer 20 creates and maintains one or more lists that map the line numbers of log entries to pattern numbers and pattern values, as previously described. Along with this mapping, the control computer 20 may also be configured to associate the particular text of the log entries (e.g., the text seen in the transaction column 58 of FIG. 2) to the line numbers (or to the pattern value or pattern number). To select a particular pattern, the user needs only to click, for example, a desired point 64 along the graph 62.

In response to receiving the user input selecting point 64, control computer 20 identifies the pattern associated with the selected point 64. Control computer 20 may then retrieve the text (e.g., the commands, parameters, and values) of the log entries associated with the selected point 64 on graph 62, and display that text in a dialog window 66 overlaid onto GUI 60. The ability to view the commands and actions, along with their associated parameters and values, can help the user in further determining any of the patterns are unusual, or whether any modifications or optimizations may be employed to optimize the database or application programs that access the database.

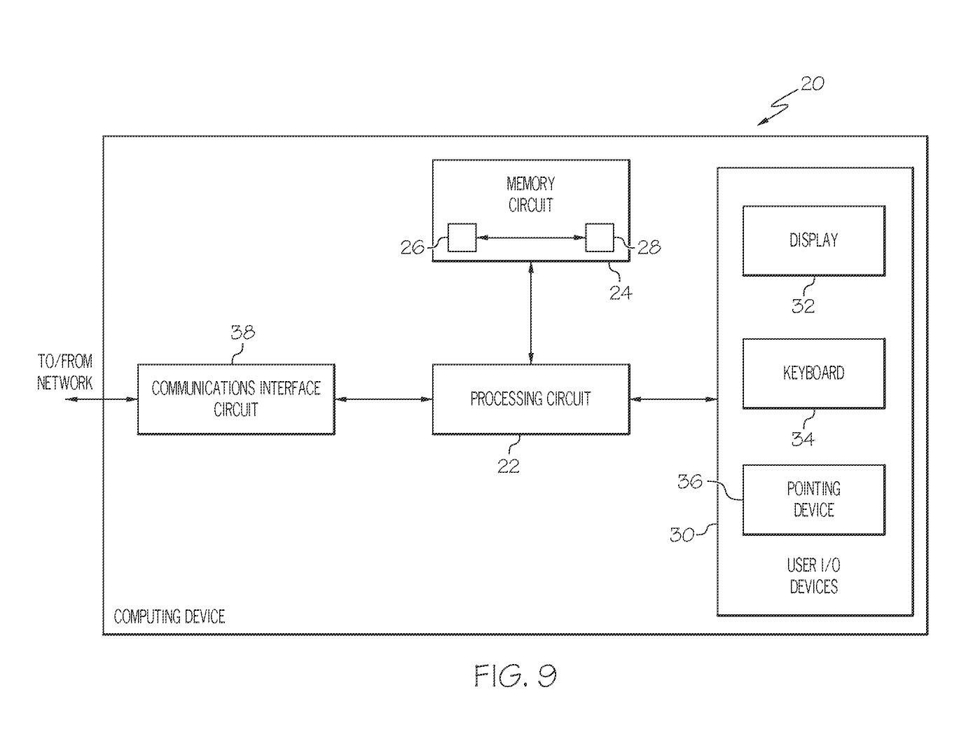

FIG. 9 is a functional block diagram of control computer 20 configured to perform the embodiments of the present disclosure. As seen in FIG. 9, control computer 20 comprises, inter alia, a processing circuit 22, memory circuitry 24, a user Input/Output (I/O) interface 30, and a communications interface circuit 38. Those skilled in the art will readily appreciate that control computer 20 is not limited solely to the components seen in FIG. 9, but rather, may comprise other hardware and/or software components as needed or desired.

Processing circuit 22 may be implemented by circuitry comprising one or more microprocessors, hardware, firmware, or a combination thereof. Generally, processing circuit 22 controls the operation and functions of the control computer 20 according to appropriate standards. Such operations and functions include, but are not limited to, communicating with DB server 16, and if needed, one or more of the user terminals 14a, 14b, 14c via network 12. Additionally, as described in the previous embodiments of the present disclosure, processing circuit 22 is configured to retrieve one or more log files via network 12, analyze the log entries in those log files to identify log entries that are similar to each other, group the similar log entries into corresponding patterns, and generate an interactive graph 62 that graphically illustrates the results of that analysis for display to the user. Further, the processing circuit is configured to execute the software that performs the analysis using the formulae mentioned above. To that end, the processing circuit 22 may be configured to implement a control program 26 stored in memory circuitry 24. The control program 26 comprises the logic and instructions needed to perform the method of the present disclosure according to the embodiments as previously described.

Memory circuitry 24 may comprise any non-transitory, solid state memory or computer readable storage media known in the art. Suitable examples of such media include, but are not limited to, ROM, DRAM, Flash, or a device capable of reading computer-readable storage media, such as optical or magnetic storage media. Memory circuitry 24 stores programs and instructions, such as the control program 26 previously mentioned, that configures the processing circuit 22 to perform the embodiments of the present disclosure as previously described. Additionally, memory circuitry 24 may also store the one or more lists 28 that map the line numbers of the log entries to corresponding pattern numbers and pattern values, as previously described. These lists, which may themselves be files, may or may not be temporary, and may be created and maintained as needed or desired.

The user I/O interface 30 comprises the components necessary for a user to interact with control computer 20. Such components include, but are not limited to, a display device 32 that is able to display GUI 60 and graph 62, as previously described, a keyboard 34, a mouse 36, any other input mechanisms that facilitate the user's ability to interact with the GUI 60 according to embodiments of the present disclosure. For example, the user may control the control computer 20 to generate graph 62, identify a particular timeframe for the analysis, and select one or more desired points along graph 62 to obtain more detailed information about the log entries and pattern associated with the selected point.

The communications interface circuitry 38 may comprise, for example, an I/O card or other interface circuit configured to communicate data and information with the DB server 16 and one or more of the user terminals 14a, 14b, 14c via network 12. As those of ordinary skill in the art will readily appreciate, the communications interface circuit 38 may communicate with these and other entities using any known protocol needed or desired. In one embodiment, however, communications interface circuitry 38 sends data to and receives data from such remote computing devices via network 12 in data packets according to the well-known ETHERNET protocol. In this regard, communications interface circuitry 28 may comprise an ETHERNET card.

The present embodiments may, of course, be carried out in other ways than those specifically set forth herein without departing from essential characteristics of the disclosure. For example, it should be noted that the flowchart and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, to blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

Thus, the foregoing description and the accompanying drawings represent non-limiting examples of the methods and apparatus taught herein. As such, the present invention is not limited by the foregoing description and accompanying drawings. Instead, the present invention is limited only by the following claims and their legal equivalents.

What is claimed is:

1. A computer-implemented method comprising:
obtaining, by a processing circuit, a log file comprising a plurality of log entries from a memory circuit, wherein each log entry is identified by a corresponding line number;
generating, by the processing circuit, a list that maps the line number of each log entry to a corresponding pattern of log entries, wherein each corresponding pattern of log entries is identified by a pattern number and represents a task performed by the computing device;
computing, by the processing circuit, a pattern value for each pattern in the list;
detecting, by the processing circuit, an anomalous pattern in the list; and
outputting, by the processing circuit, an interactive graph to a display device, wherein the interactive graph plots the pattern value for a pattern in the list to the line number of a representative log entry in that pattern, and visually indicates the anomalous pattern to the user.

2. The method of claim 1 wherein the log entries of each pattern in the list are related to the task represented by the pattern.

3. The method of claim 1 wherein generating, by the processing circuit, a list that maps the line number of each log entry to a corresponding pattern of log entries comprises:
computing a dice coefficient for first and second log entries read from the log file;
assigning the first and second log entries to a first pattern in the list if the dice coefficient exceeds a predetermined threshold value.

4. The method of claim 1 wherein computing, by the processing circuit, a pattern value for each pattern in the list comprises:
for each pattern in the list:
scaling the pattern number of the pattern by a predetermined scaling factor; and
computing a ratio of the scaled pattern number to a total number of patterns in the list as the pattern value.

5. The method of claim 4 further comprising, for each pattern in the list, associating the representative log entry of the pattern to the pattern value computed for the pattern.

6. The method of claim 1 wherein detecting, by the processing circuit, an anomalous pattern in the list comprises determining whether a selected pattern in the list diverges from a baseline pattern based on a distribution of the log entries in the selected pattern and a distribution of the log entries in the baseline pattern.

7. The method of claim 1 wherein detecting, by the processing circuit, an anomalous pattern in the list comprises:
computing a baseline probability value for a baseline pattern based on a ratio of the number of log entries in the baseline pattern to a total number of log entries in the log file;
defining a time window comprising a plurality of selected patterns;
for each selected pattern in the time window, computing a probability value based on a ratio of the number of log entries in the selected pattern to a total number of log entries in the log file; and
computing a divergence value indicating an amount of divergence between the number of log entries in each of the selected patterns in the time window and the number of log entries in the baseline pattern.

8. The method of claim 7 wherein computing a divergence value comprises:
scaling a ratio of the baseline probability value to the probability values of each of the selected patterns;
summing the scaled ratio for each of the selected patterns; and
determining that the selected patterns comprise an anomalous pattern if the divergence value for the selected patterns exceeds a predetermined divergence value threshold.

9. The method of claim 1 further comprising:
receiving, at the interactive graph, user input selecting the line number of a selected log entry; and
annotating the interactive graph with text extracted from the log entries in the pattern associated with the selected log entry.

10. A computing device comprising:
a communications interface circuit configured to communicatively connect to a communications network; and
a processing circuit operatively connected to the communications interface circuit and configured to:
obtain a log file comprising a plurality of log entries, wherein each log entry is identified by a corresponding line number;
generate a list that maps the line number of each log entry to a corresponding pattern of log entries, wherein each corresponding pattern of log entries is identified by a pattern number and represents a corresponding task performed by a computer;
compute a pattern value for each pattern in the list;
detect an anomalous pattern in the list; and
output an interactive graph to a display device, wherein the interactive graph plots the pattern value for a pattern in the list to the line number of a representative log entry in that pattern, and visually indicates the anomalous pattern to the user.

11. The computing device of claim 10 wherein the processing circuit is further configured to:
compute a dice coefficient for first and second log entries read from the log file;
assign the first and second log entries to a first pattern in the list if the dice coefficient exceeds a predetermined threshold value.

12. The computing device of claim 10 wherein, for each pattern in the list, the processing circuit is further configured to:
scale the pattern number of the pattern by a predetermined scaling factor; and
compute a ratio of the scaled pattern number to a total number of patterns in the list as the pattern value.

13. The computing device of claim 12 wherein, for each pattern in the list, the processing circuit is further configured to associate the representative log entry of the pattern to the pattern value computed for the pattern.

14. The computing device of claim 10 wherein the processing circuit is further configured to detect whether a selected pattern diverges from a baseline pattern based on a distribution of the log entries in the selected pattern and a distribution of the log entries in the baseline pattern.

15. The computing device of claim 14 wherein the baseline pattern represents a plurality of patterns.

16. The computing device of claim 10 wherein the processing circuit is further configured to:
compute a baseline probability value for a baseline pattern based on a ratio of the number of log entries in the baseline pattern to a total number of log entries in the log file;
define a time window comprising a plurality of selected patterns;
for each selected pattern in the time window, compute a probability value based on a ratio of the number of log entries in the selected pattern to a total number of log entries in the log file; and
compute a divergence value indicating an amount of divergence between the number of log entries in each of the selected patterns in the time window and the number of log entries in the baseline pattern.

17. The computing device of claim 16 wherein computing a divergence value comprises:
scaling a ratio of the baseline probability value to the probability values of each of the selected patterns;
summing the scaled ratio for each of the selected patterns; and
determining that the selected patterns comprise an anomalous pattern if the divergence value for the selected patterns exceeds a predetermined divergence value threshold.

18. The computing device of claim 10 wherein the processing circuit is further configured to:
receive user input selecting the line number of a selected log entry represented on the interactive graph; and
annotate the interactive graph with text extracted from the log entries in the pattern associated with the selected log entry.

19. A computer-readable storage medium comprising computer program code stored thereon that, when executed by a processing circuit of a computing device, configures the processing circuit to:
obtain a log file comprising a plurality of log entries, wherein each log entry is identified by a corresponding line number;
generate a list that maps the line number of each log entry to a corresponding pattern of log entries, wherein each corresponding pattern of log entries is identified by a pattern number and represents a corresponding task performed by the computing device;
compute a pattern value for each pattern in the list;
detect an anomalous pattern in the list; and
display an interactive graph on a display device for a user, wherein the interactive graph plots the pattern value for a pattern in the list to the line number of a representative log entry in that pattern, and visually indicates the anomalous pattern to the user.
